(19) United States
(12) Patent Application Publication
(10) Pub. No.: US 2024/0152747 A1
(43) Pub. Date: May 9, 2024

(54) THREE-DIMENSIONAL SPATIAL-CHANNEL DEEP LEARNING NEURAL NETWORK

(71) Applicant: UnitX, Inc., Santa Clara, CA (US)

(72) Inventor: Tommy Liu, Santa Clara, CA (US)

(21) Appl. No.: 17/983,354

(22) Filed: Nov. 8, 2022

(51) Int. Cl. G06N 3/08

(52) U.S. Cl. CPC G06N 3/08

(57) ABSTRACT

In an example embodiment, a neural network is trained to classify three-dimensional spatial-channel images in a manner that allows the training data to include two-dimensional images. Specifically, rather than redesign the neural network completely to accept three-dimensional images as input, two-dimensional slices of three-dimensional spatial-channel images are input in groupings that match the groupings that a two-dimensional image would be grouped as in the neural network. For example, if the neural network is designed to accept RGB images, it therefore is designed to accept images in groupings of three (a red component image, a green component image, and a blue component image). In such a case, the two-dimensional slices of the three-dimensional spatial-channel images will also be grouped in grouping of three so the neural network can accept them. Thus, a neural network originally designed to classify two-dimensional color images can be modified to classify three-dimensional spatial-channel images.

### TECHNICAL FIELD

This application relates generally to machine learning. More particularly, this application relates to three-dimensional spatial channel deep learning.

### BACKGROUND

Machine learning can be used in a variety of applications to perform various classification actions on digital images. Traditionally such digital images have been two-dimensional color images. Also, traditionally such two-dimensional color images were stored in a manner that separated out constituent colors from the images. For example, one way to store a two-dimensional color image is to store a different value for each of red, green, and blue colors (RGB) for each pixel in the image. Essentially, therefore, each image is stored as three images, one showing its red values, one showing its green values, and one showing its blue values.

Machine learning models that have been trained, therefore, to interpret such two-dimensional images have traditionally been trained to expect three “images” as input. In certain circumstances, however, it may be beneficial to perform the same or similar classification actions on three-dimensional images.

### BRIEF DESCRIPTION OF DRAWINGS

FIG. 1 is a block diagram illustrating a system 100, in accordance with an example embodiment.

FIG. 2 is a block diagram illustrating the neural network training and evaluation component of FIG. 1 in more detail, in accordance with an example embodiment.

FIG. 3 is a diagram illustrating a DCNN, in accordance with an example embodiment.

FIG. 4 is a flow diagram illustrating a method of training a DCNN 400, in accordance with an example embodiment.

FIG. 5 is a flow diagram illustrating a method for training and using a neural network, in accordance with an example embodiment.

FIG. 6 is a block diagram illustrating a software architecture, which can be installed on any one or more of the devices described above.

FIG. 7 illustrates a diagrammatic representation of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and computing machine program products that have illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

One way in which three-dimensional images can be classified by a machine learning model is to train the machine learning model from the ground up to expect and interpret three dimensional images. While there may be a variety of ways this can be accomplished, all of them involve obtaining three-dimensional training data in sufficient quantity to be able to adequately train the model. Since three-dimensional images, however, are much rarer than two-dimensional images, however, this creates a problem in that it is difficult to obtain a sufficient quantity of three-dimensional images to train a three-dimensional image classification model. This problem is exacerbated if the model is going to be used in a field in which three-dimensional models are not traditionally captured. For example, while it is relatively common for a computerized tomography (CT) scan machine to be used to capture a three-dimensional image of an area of a human body to be used to identify or diagnose a disease state, it is uncommon for an CT scan machine to be used to capture a three-dimensional image of a product or component (such as a battery) to identify a defect in the product or component.

In an example embodiment, a neural network is trained to classify three-dimensional images in a manner that allows the training data to include two-dimensional images. Specifically, rather than redesign the neural network completely to accept three-dimensional images as input, two-dimensional slices of three-dimensional images are input in groupings that match the groupings that a two-dimensional image would be grouped as in the neural network. It is fairly common for three-dimensional images to be captured as a series of two-dimensional images, with each having a single color channel. For example, a CT scan machine often outputs a sequence of two-dimensional grayscale images (essentially x-rays) taken as the CT scanner rotates around a patient or object. In such a case, if the neural network is designed to accept RGB images, it therefore is designed to accept images in groupings of three (a red component image, a green component image, and a blue component image), which is different from how the CT scan machine is actually outputted. In such a case, the two-dimensional slices of the three-dimensional CT scan images will also be grouped in grouping of three so the neural network can accept them. Thus, a neural network originally designed to classify two-dimensional color images can be modified to classify three-dimensional grayscale images.

This is accomplished by feeding the spatial channels captured in a three-dimensional CT scan image as color channels in the neural network (which was trained to expect color channels).

A three-dimensional spatial image is a three-dimensional image that comprises a series of two-dimensional images that each assign a single value (e.g., intensity) for each pixel (as opposed to a color-based image that assigns values for multiple different constituent colors for each pixel). One example of a three-dimensional spatial image is an image captured by a CT scan machine.

A CT scan machine is a device that aims a narrow beam of x-rays at a patient or object and then is quickly rotated around the patient or object producing signals that are processed by the CT scan machine's computer to generate cross-sectional images, or “slices.” The successive slices are digitally “stacked” together to form a 3D image.

In an example embodiment, the two-dimensional images may be grouped using a sliding window approach and fed into a neural network that has been trained using two-dimensional multichannel (e.g., color channels) images, either for training or for evaluation purposes. The sliding window approach allows the same two-dimensional spatial-channel image to be potentially input multiple different times, in different “spots” in a grouping. This allows for classification to occur within the neural network based on context. In other words, instead of each individual image being classified on its own, each image can be classified based on a preceding image and a successive image as well. This is quite useful when the image is part of a three-dimensional image where preceding and successive images may depict the same object, or portion of the object, but from slightly different angles.

The sliding window approach may be as follows. Assume a neural network that has been trained to accept groupings of three images as input, possibly since it has been trained on two-dimensional RGB images or at least set up with two-dimensional RGB images in mind. Then assume a CT scan machine is used to capture three-dimensional images of an object, such as a battery. The CT scan machine returns thousands of two-dimensional spatial-channel images of the battery as its components rotate around the battery. Using the sliding window approach with a grouping size of three, a first grouping may comprise [image 1, image 2, image 3]. A second grouping may comprise [image 2, image 3, image 4]. A third grouping may comprise [image 3, image 4, image 5]. A fourth grouping may comprise [image 4, image 5, image 6], and so on. Notice that image 3 is included in three separate groupings, allowing it to be classified based on its own channel values, but also with respect to its context in relation to images 1 and 2, with respect to its context in relation to images 2 and 4, and with respect to its context in relation to images 4 and 5.

It should be noted that it is not mandatory that the sliding window be applied to immediately successive images. In certain circumstances, it may be beneficial, for example, to skip images so that immediately successive images are not in the same grouping, such as where when CT scan machine components are rotating so slowly that there isn't a significant enough angle change from one image to the next to make a grouping useful for machine learning purposes. Thus, for example, an alternative sliding window approach with grouping size of three may have a first grouping of [image 1, image 3, image 5], a second grouping of [image 2, image 4, image 6], a third grouping of [image 3, image 5, image 7], a fourth grouping of [image 4, image 6, image 8], a fifth grouping of [image 5, image 7, image 9], and so on.

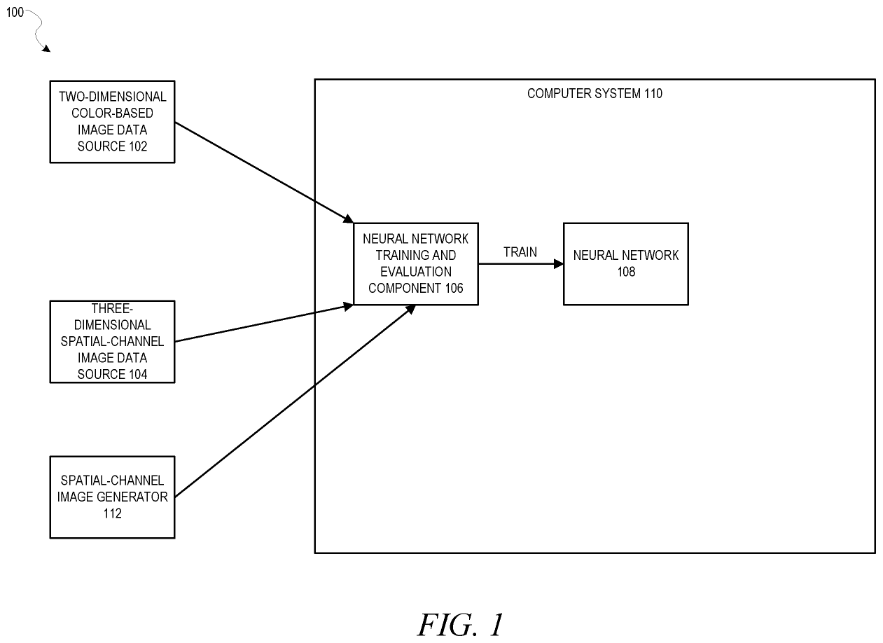

FIG. 1 is a block diagram illustrating a system 100, in accordance with an example embodiment. System 100 includes a two-dimensional color-based image data source 102 as well as a three-dimensional spatial-channel image data source 104. In an example embodiment, images from both the two-dimensional color-based image data source 102 and the three-dimensional spatial-channel image data source 104 may be used to train a neural network 106 via a neural network training and evaluation component 108 running on a computer system 110, although in some example embodiments only images from the three-dimensional spatial-channel image data source 104 is used to train the neural network 106.

Both the two-dimensional color-based image data source 102 and the three-dimensional spatial-channel image data source 104 may be repositories that contain images of their respective types. More particularly, two-dimensional color-based image data source 102 may be a repository that stores two-dimensional color-based images, such as those in RGB or Cyan, Magenta, Yellow, and Black (CYMK) color spaces. Each of these colors may be considered to be a different channel, such that, for example, an RGB image may be termed to be 3 channels and a CYMK image may be termed to be 4 channels, while a DCNN trained to accept such channels may be trained to accept each channel of each image as essentially a different, but contextually related, image to the other channels of the image. Example file formats of such files include, for example, Tagged Image File Format (TIFF), bitmap, Joint Photographic Experts Group (JPEG), Graphics Interchange Format (GIF), Portable Network Graphics (PNG), Encapsulated PostScript (EPS), and raw image files. Three-dimensional spatial-channel image data source 104 may be a repository that stores three-dimensional spatial-channel images (although in many cases these three-dimensional images will be stored as a plurality of individual two-dimensional spatial-channel images representing different “slices” of the three dimensional image). These images may be stored in some of the same formats as the two-dimensional color-based images, or may be stored in unique file formats such as Digital Imaging and Communications in Medicine (DICOM) format. In some example embodiments, either the two-dimensional color-based image data source 102 or the three-dimensional spatial-channel image data source 104 or both may be public repositories.

Images from the two-dimensional color-based image data source 102 or the three-dimensional spatial-channel image data source 104 may be augmented by adding one or more labels to them. This may involve transforming the images to a different format to accept such labels. The labels added may depend on what the neural network 106 is being trained to do, and specifically may correspond to classifications that the neural network 106 is expected to perform. For example, if an image shows an example of a defect in a particular component, it may be labeled as such so that the neural network 106 can learn what a defect in that particular component looks like. This is an example of a positive label. Additionally, if an image shows an example of the component without a defect, it may be labeled as such so that the neural network 106 can learn what a non-defective component looks like. This is an example of a negative label. While these examples are binary (e.g., either positive or negative), in reality the labels may have any number of values depending on the classifications being performed by the neural network 106.

System 100 may also include a spatial-channel image generator 112. The spatial-channel image generator 112 generates spatial-channel images that are to be evaluated by the neural network 106, such as to identify defects in components being scanned by the spatial-channel image generator 112. In an example embodiment, the spatial-channel image generator 112 may include a CT scan machine and optionally an associated computer system that processes data from the CT scan machine into spatial-channel images. Nevertheless, the spatial-channel image generator 112 may be any component that generates spatial-channel images and nothing in this disclosure shall be interpreted as limiting the scope of protection to CT scan machines or systems, unless expressly recited.

Generally, images from the two-dimensional color-based image data source 102 and the three-dimensional spatial-channel image data source 104 can be used to train the neural network 108 while images from the spatial-channel image generator 112 are evaluated by the trained neural network 106, although that is not mandatory. In some instances, for example, images from the spatial-channel image generator 112 may be used to train the neural network 106 while images from either the two-dimensional color-based image data source 102 or the three-dimensional spatial-channel image data source 104 may be evaluated by the neural network.

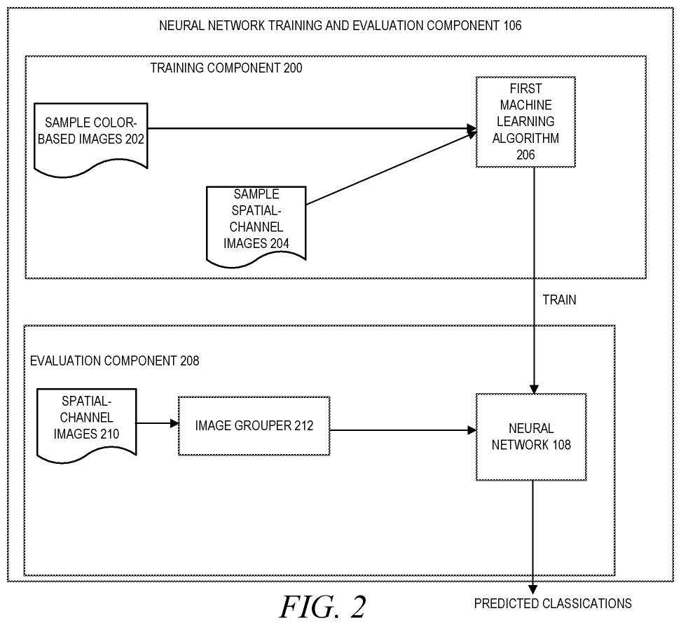

FIG. 2 is a block diagram illustrating the neural network training and evaluation component 108 of FIG. 1 in more detail, in accordance with an example embodiment. In a training component 200, sample color-based images 202 and sample spatial-channel images 204 (both with labels) are fed to a first machine learning algorithm 206 to train the neural network 106 to classify runtime images.

In an evaluation component 208, spatial-channel images 210 lacking labels are passed to an image grouper 212. The image grouper 212 groups the spatial-channel images in groups of size N, wherein N is greater than 1 and is equal to a grouping size expected by the neural network 108. In cases where the neural network 108 has been previously trained on sample color-based images 202 of a particular grouping size (such as a grouping size of 3 for RGB images or a grouping size of 4 for CYMK images), N may be set to that particular grouping size, eliminating the need to completely retrain the neural network 108. In essence, the neural network 108 is able to keep its previous training (based on color-based images alone) but still be useful in evaluating spatial-channel images. The images within each group are ordered, as the sequence of the spatial-channel images may be relevant to the context of one or more aspects of an image. As mentioned above, the image grouper 212 may group the images using a sliding window approach, such that the same image appears in different groups (albeit in different spots within each group). The image grouper 212 then passes each group to the neural network 108, which outputs one or more classifications of the spatial-channel images 210. In some example embodiments, the neural network 108 outputs classifications of individual images. In other example embodiments, the neural network 108 outputs classifications of groupings of images. In yet other example embodiments, the neural network 108 outputs classifications of three-dimensional images by classifying the entirety of a plurality of groupings that constitute a three-dimensional image. For example, if a CT scan machine outputs a thousand images as it rotates its components around a battery being examined for defects, there may be thousand groupings of different combinations of the images that may be considered to be a single three-dimensional image. The neural network 108 can output its classification for this single three-dimensional image, essentially classifying all thousand groupings at the same time.

In an example embodiment, the neural network 108 is a Deep Convolutional Neural Network (DCNN). A DCNN is a machine-learning model that effectively infers non-linear relationships between a homogeneous input field and desired outputs, which are either categorical classes or scalars. The DCNN is a model that maps inputs to outputs using a sequence of so-called convolutional layers of artificial neurons. The DCNN may be trained by presenting it with a large number (e.g., greater than 10,000) of sample data and labels. It is trained to minimize the discrepancy (or “loss”) between the mode's output and the desired output. After the training, the model may be applied to new input images to produce a useful prediction of the professionalism levels of the new input images.

The DCNN is designed to learn not only to classify images or groupings of images, but also to learn a feature hierarchy by defining a number of layers. The process of inference involves taking a given input, applying a sequence of mathematical functions called layers, and calculating the functions on the input data. Each layer extracts features from the output of a previous layer, and all layers are trained jointly. The layer-based architecture is why it is termed a “deep” convolutional neural network.

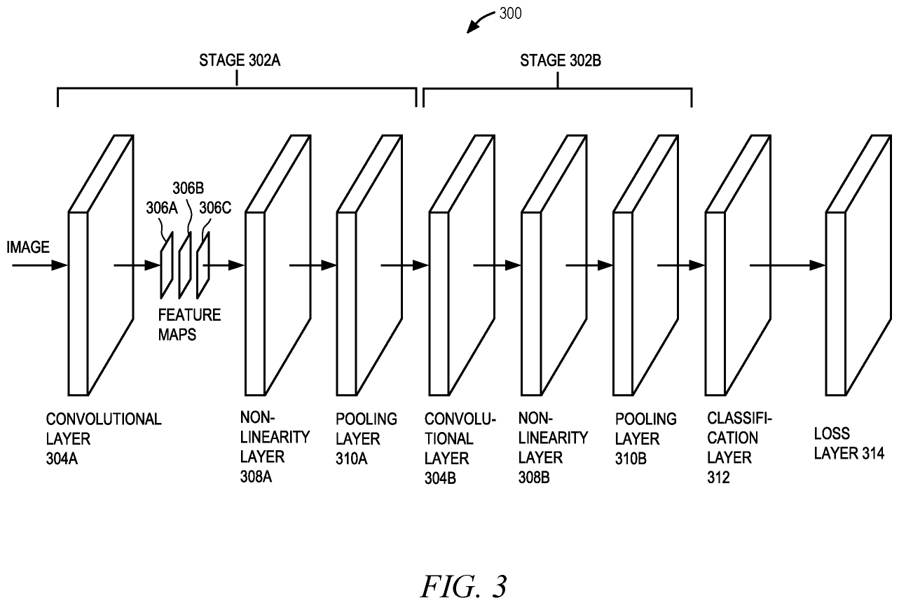

In an example embodiment, five different types of layers are utilized. The first four layers are the convolutional layer, the nonlinearity layer, the pooling layer, and the classification layer (although the classification is just a special case of convolution followed by “softmax”). These first four layers may be considered to be a stage, and the DCNN may actually be designed to have any number of these stages. Once the stages are all complete, a loss layer is used. FIG. 3 is a diagram illustrating a DCNN 300, in accordance with an example embodiment. Here, two stages 302A, 302B are depicted.

Convolutional layers 304A, 304B are the core of the DCNN 300. Their parameters include a set of learnable filters that have a small receptive field but extend through the full depth of the input data. During a forward pass in a convolutional layer 304A, 304B, each filter is convolved across the features, computing the dot product between the entries of the filter and the input and producing a 2-dimensional activation map of that filter. As a result, the DCNN 300 learns filters that activate when they see some specific type of feature.

The feature maps for all filters can be stacked along the depth dimension to form the full volume output of the convolutional layers 304A, 304B.

The convolutional layers 304A, 304B apply mathematical operations called convolutionals. For two spatial dimensions and an indeterminate amount of non-spatial dimensions (referred to as “channels”), the convolutional is defined using the * operator as follows:

$$y [ n , m , d ] = x * f = {\sum }_{o} {\sum }_{j = - M , k = - N}^{j = M , k = N} x [ n , m , o ] {f}_{d} [ n - k , m - j , o ]$$

The convolutional layers 304A, 304B will typically have some very small support, e.g., N=1 and M=1, such that g[n, m, d]=0 if |n|>1 or |m|>1.

It should be noted that the filters used in the convolutional layers 304A, 304B may be activated in a first iteration of the DCNN 300 and refined prior to each additional iteration, based on actions taken in other layers in the previous iteration, until some error term is minimized below a particular threshold. In one example embodiment, this may be accomplished through back propagation, which is described in more detail below.

The output of the convolutional layers 304A, 304B are sets of arrays called feature maps 306A-306C. Each feature map 306A-306C may be produced by a different filter and modified based on various functions in each stage. At the output, each feature map 306A-306C represents a particular feature extracted at all locations on the input and conditioned. The example in FIG. 3 is of a two-stage system, although one of ordinary skill in the art will recognize that more or fewer stages could be used while still being consistent with the present disclosure, and indeed as will be seen in an example embodiment, the number of stages may be dynamically determined at runtime to optimize results.

Nonlinearity layers 308A, 308B give the DCNN 300 greater expressive power in uncovering nonlinear relationships between input and output. Many different nonlinearities could be used in the nonlinearity layer, including sigmoid, tanh, and rectified linear function. For brevity, one example of nonlinearity will be described here: the rectified linear function. This function is defined by the following:

$$y ( x ) = \{ \begin{matrix}x if x > 0 \\ 0 if x < 0\end{matrix}$$

Pooling layers 310A, 310B are applied to lower the input image's spatial dimensions while preserving some information from the input image. In other words, the pooling layers 310A, 310B do not actually do any of the learning, i.e., they are a fixed predefined operation that does not change as training progresses. Instead, they are used as the spatial dimensions of the problem. In one example embodiment, a decimation approach could be followed, where one out of every N samples along a spatial dimension is kept out. In another example embodiment, some local statistics may be used for pooling, such as max pooling, defined as:

$$Y [ n , m , d ] = {max}_{\vert {n}^{′} \vert < N , \vert {m}^{′} \vert < M} x [ n + {n}^{′} , m + {m}^{′} , d ]$$

where N=M=2.

When all the stages 302A, 302B are complete, a classification layer 312 is used to classify the image using the output of the final pooling layer 310B. As stated above, the classification layer 312 is actually a specialized convolutional layer containing a filter designed to produce the score from the volume output of the final pooling layer 310B. This filter applies a classification function having weights that may be refined in the same manner as the weights in the functions of the filters of the normal convolutional layers 304A, 304B.

Back propagation involves calculating a gradient of a loss function (defined later) in a loss layer 314, with respect to a number of weights in the DCNN 300. The gradient is then fed to a method that updates the weights for the next iteration of the training of the DCNN 300 in an attempt to minimize the loss function, which uses a different plurality of sample data (unless there is a need to repeat, such as running out of sample data). Back propagation uses the labeled sample data in a batch of sample data that have been passed through the stages 302A, 302B in order to calculate the loss function gradient for the samples as a group (although, as will be seen later, the loss function may be modified dynamically to eliminate some of the samples from consideration).

Back propagation may include two aspects: propagation and weight update. In the propagation aspect, forward propagation of a training pattern's input images is performed through the DCNN 300 in order to generate the propagation's output activations (i.e., the images are passed through the stages 302A, 302B). Then, backward propagation of the propagation's output activations are performed through the DCNN 300 using a target specified by the training pattern in order to generate the deltas of all output.

In the weight update aspect, for each weight of each filter, the output delta and input activation are multiplied to obtain the gradient of the weight, and then a ratio of the gradient is subtracted from the weight. The ratio influences speed and quality of learning. The higher the ratio, the faster the training, but at the expense of accuracy.

Thus, these two aspects, including both the forward pass and the backward pass through the stages 302A, 302B, are performed repeatedly until the error rate is below a particular threshold. An example of back propagation algorithms compatible with the DCNN 300 include, for example, gradient descent.

The use of the back propagation may be predicated on whether the combined error of the classification of the images in the batch of labeled sample data transgressed a preset error threshold. If the combined error is too great, then back propagation should occur to update and hopefully minimize the error for the next iteration, and a next iteration is performed with a subsequent batch of labeled sample data, until the combined error does not transgress the threshold.

As described above, the classification may be scored for the data. The DCNN 300 outputs a vector that may be compared to the desired output of some loss function, such as the sum square error function:

$$loss = {\sum }_{i} {( \hat{{l}_{i}} - {l}_{i} )}^{2}$$

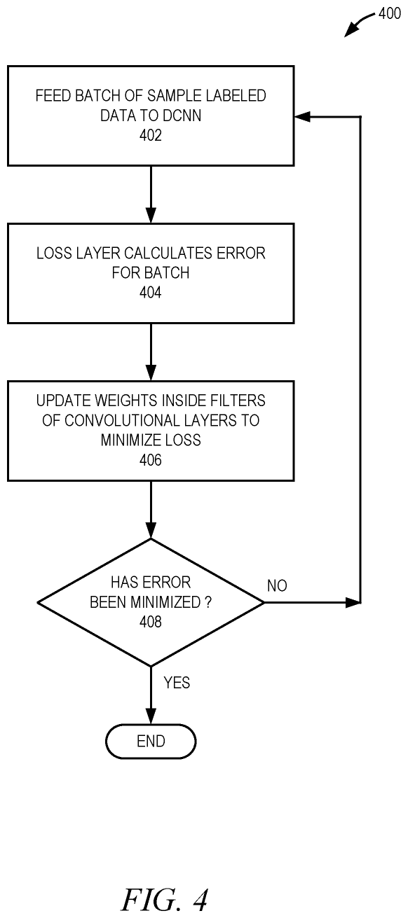

FIG. 4 is a flow diagram illustrating a method 400 of training a DCNN 300, in accordance with an example embodiment. At operation 402, a batch of sample labeled data are fed to the DCNN 300 and the current model of the DCNN 300 produces an output. This output may be, for example, a score for each sample labeled datum. At operation 404, the loss layer 314 of the DCNN 300 calculates the error for the batch of sample data. This error may be, for example, a combination of the individual errors for each of the individual sample labeled data. At operation 406, weights inside the filters in the convolutional layers 304A, 304B (which also include the classification layer 312) are updated to minimize the loss, in accordance with the loss function defined in the loss layer 314. At operation 408, it is determined if the error has been minimized, based on a defined validation set. This defined validation set may include an error threshold, and if that error threshold has been transgressed, then the error has not been minimized and the process repeats back to operation 402 for the next batch of sample labeled images. If the error has been minimized (the threshold has not been transgressed), then the DCNN has been trained.

As mentioned before, there may be disconnect between type and format of images used to train the DCNN 300 and those that are passed to it at evaluation-time and/or used to retrain it. For example, the DCNN 300 may have initially been trained on two-dimensional RGB images (which involves essentially passing 3 images for each image—one for each of the red, green, and blue values) but at evaluation-time a process is utilized to evaluate three-dimensional spatial-channel images, by passing each of three successive spatial-channel images to the DCNN 300. Likewise, such three-dimensional spatial-channel images may be used to retrain the DCNN 300.

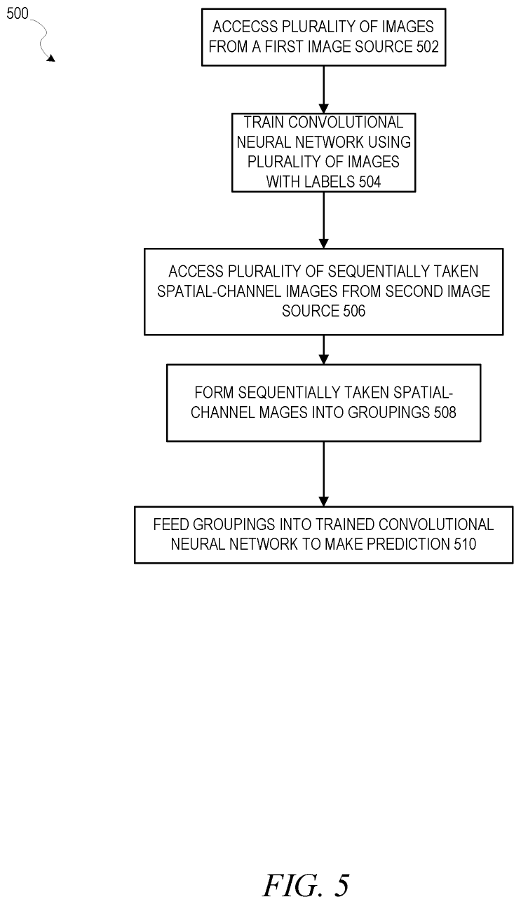

FIG. 5 is a flow diagram illustrating a method 500 for training and using a neural network, in accordance with an example embodiment. At operation 502, a plurality of images from a first image data source are accessed. The plurality of images each have n number of color channels. At operation 504, a convolutional neural network is trained using the plurality of images and a plurality of labels. Each label corresponding to a classification (e.g., “defective component,” “non-defective component”) that the convolutional neural network is being trained to predict.

At operation 506, a plurality of sequentially taken spatial-channel images from a second image data source are accessed. The second image data source may be, for example, a CT scan machine. Each of the spatial-channel images contains a spatial-channel, the sequentially taken spatial-channel images having a first order based upon when they were taken. Each spatial-channel image may be a different slice of a three-dimensional image from a three-dimensional image generator.

At operation 508, the plurality of sequentially taken spatial-channel images are formed into a plurality of groupings of n spatial-channel images, wherein each grouping contains a different combination of the sequentially taken spatial-channel images. The forming the plurality of sequentially taken spatial-channel images into a plurality of groupings may include utilizing a sliding window method, such that each grouping contains an ordered group of spatial-channel images in an order that matches the first order, and wherein some of the spatial-channel images reappear in n different positions in n different groupings. In an example embodiment, each grouping contains images taken immediately sequentially to one another, but in other example embodiments the images in a grouping are not taken immediately sequentially to one another (e.g., one or more images are skipped over).

At operation 510, the plurality of groupings are fed into the trained convolutional neural network to make a prediction of a classification for each of the plurality of groupings.

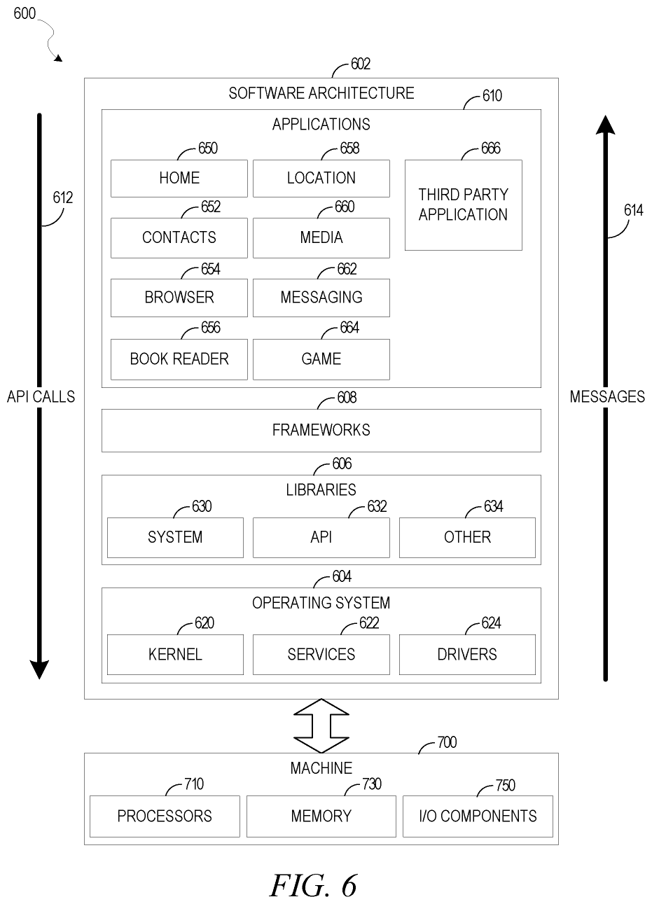

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 97 that includes processors 910, memory 930, and input/output (I/O) components 950. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke Application Program Interface (API) calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware. For instance, the drivers 624 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610. For example, the frameworks 608 provide various graphical user interface functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. The applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating system. In this example, the third-party application 666 can invoke the API calls 612 provided by the operating system 604 to facilitate functionality described herein.

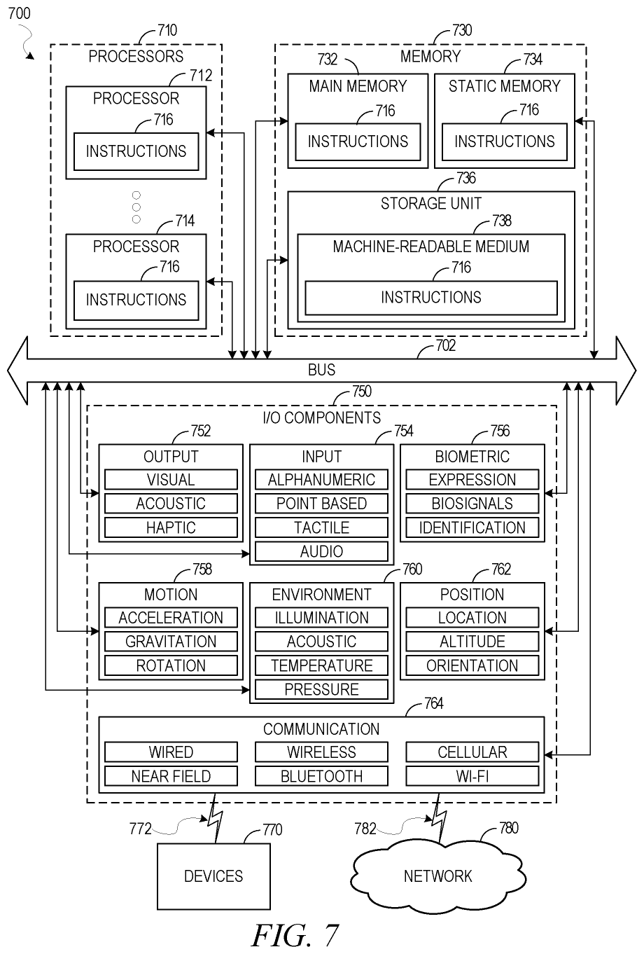

FIG. 7 illustrates a diagrammatic representation of a machine 700 in the form of a computer system within which a set of instructions may be executed for causing the machine 700 to perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) cause the machine 700 to perform any one or more of the methodologies discussed herein to be executed. For example, the instructions 716 may cause the machine 700 to execute the method of FIG. 5. Additionally, or alternatively, the instructions 716 may implement FIGS. 1-5 and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor 712), multiple processors 712, 714 with a single core, multiple processors 712, 714 with multiple cores, or any combination thereof.

The memory 730 may include a main memory 732, a static memory 734, and a storage unit 736, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., coupled via a USB).

Moreover, the communication components 764 may detect identifiers or include components operable to detect identifiers. For example, the communication components 764 may include radio-frequency identification (RFID) tag reader components, NFC smart tag detection components, optical reader components (e.g., an optical sensor to detect one-dimensional bar codes such as Universal Product Code (UPC) bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., Hypertext Transfer Protocol (HTTP)). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

1. A system comprising:
a first image data source;
a second image data source;
a computer system comprising at least one hardware processor and a non-transitory computer-readable medium storing instructions that, when executed by the at least one hardware processor, cause the at least one hardware processor to perform operations comprising:
accessing a plurality of images from the first image data source, the plurality of images each having n number of color channels;
training a convolutional neural network using the plurality of images and a plurality of labels, each label corresponding to a classification;
accessing a plurality of sequentially taken spatial-channel images from the second image data source, the plurality of sequentially taken spatial-channel images having a first order based upon when they were taken;
forming the plurality of sequentially taken spatial-channel images into a plurality of groupings of n spatial-channel images, wherein each grouping contains a different combination of the plurality of sequentially taken spatial-channel images; and
feeding the plurality of groupings into the trained convolutional neural network to make a prediction of a classification for each of the plurality of groupings.

2. The system of claim 1, wherein the forming the plurality of sequentially taken spatial-channel images into a plurality of groupings includes utilizing a sliding window method, such that each grouping contains an ordered group of spatial-channel images in an order that matches the first order, and wherein some of the plurality of sequentially taken spatial-channel images reappear in n different positions in n different groupings.

3. The system of claim 1, wherein the second image data source is a computerized tomography (CT) scan machine.

4. The system of claim 1, wherein the images from the first image data source are two-dimensional and wherein the second image data source is a three-dimensional image generator.

5. The system of claim 4, wherein each spatial-channel image is a different slice of a three-dimensional image from the three-dimensional image generator.

6. The system of claim 1, wherein the classification for each of the plurality of groupings is an indication of whether a defect is detected in a component in the plurality of sequentially taken spatial-channel images.

7. The system of claim 2, wherein each grouping contains images taken immediately sequentially to one another.

8. A method comprising:
accessing a plurality of images from a first image data source, the plurality of images each having n number of color channels;
training a convolutional neural network using the plurality of images and a plurality of labels, each label corresponding to a classification;
accessing a plurality of sequentially taken spatial-channel images from a second image data source, each of the spatial-channel images containing a spatial-channel, the plurality of sequentially taken spatial-channel images having a first order based upon when they were taken;
forming the plurality of sequentially taken spatial-channel images into a plurality of groupings of n spatial-channel images, wherein each grouping contains a different combination of the plurality of sequentially taken spatial-channel images; and
feeding the plurality of groupings into the trained convolutional neural network to make a prediction of a classification for each of the plurality of groupings.

9. The method of claim 8, wherein the forming the plurality of sequentially taken spatial-channel images into a plurality of groupings includes utilizing a sliding window method, such that each grouping contains an ordered group of spatial-channel images in an order that matches the first order, and wherein some of the plurality of sequentially taken spatial-channel images reappear in n different positions in n different groupings.

10. The method of claim 8, wherein the second image data source is a CT scan machine.

11. The method of claim 8, wherein images from the first image data source are two-dimensional and wherein the second image data source is a three-dimensional image generator.

12. The method of claim 11, wherein each spatial-channel image is a different slice of a three-dimensional image from the three-dimensional image generator.

13. The method of claim 8, wherein the classification for each of the plurality of groupings is an indication of whether a defect is detected in a component in the plurality of sequentially taken spatial-channel images.

14. The method of claim 9, wherein each grouping contains images taken immediately sequentially to one another.

15. A non-transitory machine-readable storage medium having embodied thereon instructions executable by one or more machines to perform operations comprising:
accessing a plurality of images from a first image data source, the plurality of images each having n number of color channels;
training a convolutional neural network using the plurality of images and a plurality of labels, each label corresponding to a classification;
accessing a plurality of sequentially taken spatial-channel images from a second image data source, each of the plurality of spatial-channel images containing a spatial-channel, sequentially taken spatial-channel images having a first order based upon when they were taken;
forming the plurality of sequentially taken spatial-channel images into a plurality of groupings of n spatial-channel images, wherein each grouping contains a different combination of the plurality of sequentially taken spatial-channel images; and
feeding the plurality of groupings into the trained convolutional neural network to make a prediction of a classification for each of the plurality of groupings.

16. The non-transitory machine-readable storage medium of claim 15, wherein the forming the plurality of sequentially taken spatial-channel images into a plurality of groupings includes utilizing a sliding window method, such that each grouping contains an ordered group of spatial-channel images in an order that matches the first order, and wherein some of the plurality of sequentially taken spatial-channel images reappear in n different positions in n different groupings.

17. The non-transitory machine-readable storage medium of claim 15, wherein the second image data source is a CT scan machine.

18. The non-transitory machine-readable storage medium of claim 15, wherein the images from the first image data source are two-dimensional and wherein the second image data source is a three-dimensional image generator.

19. The non-transitory machine-readable storage medium of claim 18, wherein each spatial-channel image is a different slice of a three-dimensional image from the three-dimensional image generator.

20. The non-transitory machine-readable storage medium of claim 15, wherein the classification for each of the plurality of groupings is an indication of whether a defect is detected in a component in the plurality of sequentially taken spatial-channel images.
